(19) United States
(12) Patent Application Publication
(10) Pub. No.: US 2013/0074719 A1
(43) Pub. Date: Mar. 28, 2013

(54) METHOD AND APPARATUS FOR PRODUCING SLEEVE PRINTING PLATE

(71) Applicants: Tatsuya Hanafusa, Sunto-gun (JP); Hiroaki Hashimoto, Sunto-gun (JP); Naoto Honda, Fukuoka-shi (JP)

(72) Inventors: Tatsuya Hanafusa, Sunto-gun (JP); Hiroaki Hashimoto, Sunto-gun (JP); Naoto Honda, Fukuoka-shi (JP)

(73) Assignee: Universal Can Corporation, Tokyo (JP)

(21) Appl. No.: 13/247,299

(22) Filed: Sep. 28, 2011

(51) Int. Cl. B41C 1/02; B41J 2/47

(52) U.S. Cl. 101/401.1; 347/225

(57) ABSTRACT

The present invention is a method for producing a sleeve printing plate which is attached to a cylinder of a printing apparatus, including a notch forming step in which, a laser beam is irradiated to the sleeve element assembly while rotating a sleeve element assembly attached to a rotating drum together with the rotating drum, thereby forming a positioning notch which is engaged with a guide pin erected on the cylinder and an image pattern forming step in which the laser beam is irradiated to the sleeve element assembly while rotating the sleeve element assembly attached to the same rotating drum as that of the notch forming step together with the rotating drum, thereby forming an image pattern to be printed on a work piece.

### BACKGROUND OF THE INVENTION

1. Field of the Invention

The present invention relates to a method and an apparatus for producing a sleeve printing plate.

2. Background Art

As disclosed, for example, in Japanese Published Unexamined Patent Application No. 2006-326938, a sleeve printing plate has been widely used in flexographic printing and relief printing. Further, as disclosed in Japanese Published Unexamined Patent Application No. 2006-272682, the sleeve printing plate has been used in offset printing for cylindrical articles such as cans.

In the sleeve printing plate, an image pattern is set in advance for a circumferential position thereof on a sleeve supporter. Therefore, the sleeve supporter can be positioned with respect to a cylinder to register the image pattern. Thereby, it is possible to greatly reduce the time and labor necessary for exchanging the image pattern.

In this instance, in the above-described sleeve printing plate, a positioning notch opened toward an end of the axial direction is provided at a part of the sleeve supporter. The notch is engaged with a guide pin erected on the cylinder, by which the sleeve printing plate is positioned relatively with respect to the cylinder both in the circumferential direction and in the axial direction.

The above-described conventional sleeve printing plate is in general constituted with a fiber reinforced plastic (FRP)-made sleeve supporter and a plate main body on which an image pattern is formed and which is disposed on an outer circumferential face of the sleeve supporter and made of a photosensitive resin which can be engraved, for example, by a laser beam. In this instance, the sleeve supporter is about 1 mm in thickness and formed in a cylindrical shape.

The thus constituted sleeve printing plate is produced by the following procedures. First, a reinforced fiber is coiled around a fixed base having a cylindrical face and a melted plastic resin is then applied thereto and cured. These procedures are repeated to produce a fiber reinforced plastic (FRP)-made sleeve supporter. Subsequently, a printing material is disposed all over an outer circumferential face of the sleeve supporter to produce a sleeve element assembly.

A notch is formed by machining at an end of the sleeve element assembly in the axial direction. Next, with reference to the notch, an image pattern is formed on the outer circumferential face of the printing material by using a laser processing machine, a photolithography machine and so on.

Incidentally, in the above-described method for producing a sleeve printing plate, the positioning notch is formed by machining and, thereafter, the image pattern is formed by using other processing machines with reference to the notch. As a result, a positioning relationship between the image pattern and the notch is deviated depending on the positioning accuracy in forming the image pattern, thus resulting in possible failure in providing high-quality printing. Therefore, in spite of the considerable effort in using the sleeve printing plate, necessary to perform the positioning accurately for each sleeve printing plate, and time and labor necessary for exchanging the image pattern cannot be reduced.

The present invention has been made in view of the above situation, an object of which is to provide a method and an apparatus for producing a sleeve printing plate capable of forming a positioning notch and an image pattern accurately in such a manner that their relative positions are in alignment.

### SUMMARY OF THE INVENTION

The method for producing a sleeve printing plate according to the present invention is a method for producing a sleeve printing plate which is attached to a cylinder of a printing apparatus. The method is composed of a notch forming step in which a laser beam is irradiated to the sleeve element assembly while rotating a sleeve element assembly attached to a rotating drum together with the rotating drum, thereby forming a positioning notch which is engaged with a guide pin erected on the cylinder and an image pattern forming step in which the laser beam is irradiated to the sleeve element assembly while rotating the sleeve element assembly attached to the same rotating drum as that of the notch forming step together with the rotating drum, thereby forming an image pattern to be printed on a work piece.

According to the method for producing a sleeve printing plate of the present invention, in a state that the sleeve element assembly is attached to the rotating drum of one sleeve element assembly-supporting unit, the positioning notch forming step and the image pattern forming step are carried out. Therefore, there is no concern that a relative position between the positioning notch and the image pattern will be deviated, thus making it possible to produce the sleeve printing plate capable of providing high-quality printing.

In the method of the present invention, the notch forming step and the image pattern forming step may be carried out by scanning once an outer circumferential face of the sleeve element assembly with the laser beam, while adjusting the laser beam for energy density.

According to the present invention, there is provided an energy density adjusting unit for controlling the energy density of a laser beam. Thus, when a notch is formed, the energy density can be made relatively high to remove the sleeve element assembly entirely in the thickness direction, and when an image pattern is formed, the energy density is made relatively low to remove the sleeve element assembly only partially in the thickness direction. Thereby, during a period of time when an outer circumferential face of the sleeve element assembly is scanned once with a laser beam, it is possible to form the notch and the image pattern. As a result, it is possible to efficiently produce the sleeve printing plate and further enhance the accuracy of a relative position between the notch and the image pattern.

In the method of the present invention, there may be also provided a cutting step for cutting the sleeve element assembly into a plurality of units divided in the axial direction while rotating the sleeve element assembly attached to the same rotating drum as that of the notch forming step and that of the image pattern forming step and irradiating the laser beam to the sleeve element assembly. Each unit of the sleeve element assembly constitutes the sleeve printing plate.

According to the present invention, since the present invention is provided with the cutting step for cutting a long sleeve element assembly, it is possible to produce a plurality of sleeve printing plates from a single sleeve element assembly. It is, thereby, possible to attain efficient production of the sleeve printing plate. Further, since the cutting step, the notch forming step and the image pattern forming step are carried out in a state that the sleeve printing plate is attached to the same sleeve element assembly-supporting unit, the sleeve printing plate can be made more accurate in length in the axial direction, and the notch can be positioned with respect to the image pattern more accurately.

In the method of the present invention, the cutting step may be carried out together with the notch forming step and the image pattern forming step by scanning once the outer circumferential face of the sleeve element assembly with the laser beam, while adjusting the laser beam for energy density.

According to the present invention, there is provided the energy density adjusting unit for controlling the energy density of a laser beam. Therefore, when the notch is formed and also when the sleeve element assembly is cut, the energy density can be made relatively high to remove the sleeve element assembly entirely in the thickness direction, and when the image pattern is formed, the energy density can be made relatively low to remove the sleeve element assembly only partially in the thickness direction. Therefore, the sleeve element assembly can be cut and the notch and the image pattern can be formed to produce more efficiently the sleeve printing plate by scanning once the outer circumferential face of the sleeve element assembly by a laser beam. Further, the sleeve printing plate can be made more accurate in length in the axial direction, and the notch can be positioned with respect to the image pattern more accurately.

In the method of the present invention, the thickness of the sleeve element assembly may be 0.1 mm or more and 1.0 mm or less. According to the present invention, since the thickness of the sleeve element assembly is 0.1 mm or more, rigidity is secured as the sleeve printing plate, thus making it possible to prevent deformation of the image pattern and the notch by elongation and so on. Further, since the thickness of the sleeve element assembly is 1.0 mm or less, the sleeve element assembly can be securely removed entirely in the thickness direction by laser processing and so on, and the notch can be formed efficiently.

The method of the present invention may be carried out by using a laser processing machine which is provided with a sleeve element assembly-supporting unit which has a rotating drum capable of attaching a cylindrical sleeve element assembly to an outer circumferential face thereof and a pivot supporting portion for supporting the rotating drum so as to rotate freely, and a laser beam irradiating unit which irradiates a laser beam to the sleeve element assembly attached to the rotating drum. The laser processing machine may be provided with an energy density adjusting unit for adjusting the energy density of a laser beam irradiated to the sleeve element assembly.

According to the present invention, heat resulting from processing will cause local actions when the laser processing machine is used to form the notch and the image pattern, thus making it possible to suppress deformation of the sleeve printing plate.

In the method of the present invention, carbon dioxide gas laser may be used for the laser beam irradiating unit. According to the present invention, since the laser is relatively high in output, this makes it possible to remove the sleeve element assembly entirely in the thickness direction and form the positioning notch efficiently and securely.

The apparatus for producing a sleeve printing plate of the present invention is an apparatus for producing a sleeve printing plate which is provided with a positioning notch to be engaged with a guide pin erected on a cylinder of a printing apparatus and an image pattern to be printed on a work piece and which is attached to the cylinder.

The apparatus of the present invention is provided with a sleeve element assembly-supporting unit which has a rotating drum capable of attaching a cylindrical sleeve element assembly to an outer circumferential face thereof and a pivot supporting portion for supporting the rotating drum so as to rotate freely, a laser beam irradiating unit which irradiates a laser beam to the sleeve element assembly attached to the rotating drum while rotating the sleeve element assembly, thereby forming the notch and the image pattern on the sleeve element assembly, and a control unit for controlling the rotating drum and the laser beam irradiating unit.

The control unit is provided with a storage unit which stores first image data indicating a position on the sleeve element assembly on which the notch is to be formed and a shape of the notch as well as second image data indicating a position on the sleeve element assembly on which the image pattern is to be formed and a shape of the image pattern, and an energy density adjusting unit which adjusts the energy density of the laser beam in forming the notch on the basis of the first image data and in forming the image pattern on the basis of the second image data.

Since the apparatus of the present invention is provided with the storage unit which stores the first image data indicating the notch forming position for positioning and the shape thereof as well as the second image data indicating the position of the image pattern and the shape thereof, it is possible to form the notch and the image pattern on the basis of the first image data and the second image data. The apparatus of the present invention is also provided with the energy density adjusting unit which adjusts respectively the energy density of a laser beam in forming the notch on the basis of the first image data and the energy density of a laser beam in forming the image pattern on the basis of the second image data. It is, therefore, possible to adjust the depth of laser processing with respect to the sleeve element assembly and favorably form the notch and the image pattern.

In the apparatus of the present invention, the first image data may also indicate a position of cutting the sleeve element assembly and a shape thereof, in addition to the position on the sleeve element assembly on which the notch is to be formed and the shape of the notch. A laser beam is irradiated on the basis of the first image data, thus making it possible to cut the sleeve element assembly and also form the notch.

According to the present invention, it is possible to provide a method and an apparatus for producing a sleeve printing plate which is capable of forming accurately a positioning notch and an image pattern so that their relative positions are in alignment.

### BRIEF DESCRIPTION OF THE DRAWINGS

FIG. 1 is a perspective view of a sleeve printing plate which is produced by a method and an apparatus for producing a sleeve printing plate, according to an embodiment of the present invention.

FIG. 2 is a view of the sleeve printing plate shown in FIG. 1 viewed from the axial direction.

FIG. 3 is a schematic view of the apparatus for producing a sleeve printing plate which is the present embodiment.

FIG. 4 is a view for explaining a sleeve element assembly, first image data and second image data which are used for the method for producing a sleeve printing plate which is the present embodiment.

### PREFERRED EMBODIMENTS

Hereinafter, an explanation will be made for the embodiments of the present invention by referring to the attached drawings.

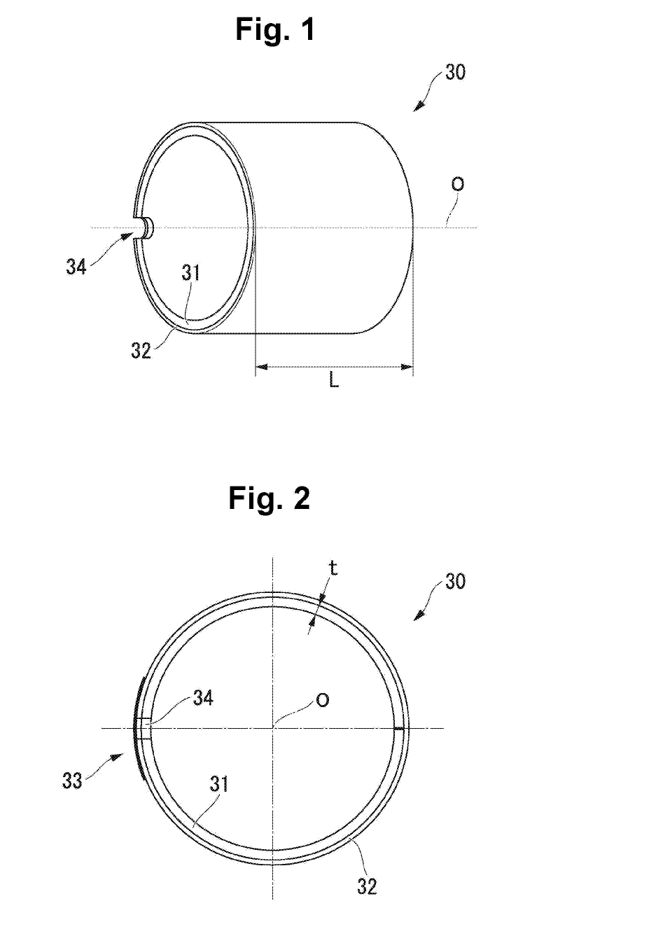

First, an explanation will be made for a sleeve printing plate 30 which is produced by an apparatus 50 and a method for producing a sleeve printing plate which are the present embodiments by referring to FIG. 1 and FIG. 2.

As shown in FIG. 1 and FIG. 2, the sleeve printing plate 30 is provided with a cylindrical sleeve supporter 31 extending along the axis line O and a printing material 32 disposed on an outer circumference of the sleeve supporter 31.

The sleeve supporter 31 is formed of a polyethylene terephthalate (PET) resin, and measures 100 mm≦D≦300 mm in outer diameter D and 50 mm≦L≦600 mm in length L in the axis line O and is set so that a ratio of outer diameter D to length L in the axis line O, that is, a ratio of L/D is 0.2≦L/D≦2. Further, the thickness t of the sleeve supporter 31 is set to be 0.1 mm≦t≦1.0 mm. In the present embodiment, the length of the sleeve supporter 31 in the axis line O is set at 200 mm.

The printing material 32 is made of, for example, a photosensitive resin which can be engraved by a laser beam and formed in a cylindrical shape, the thickness of which is from 0.5 mm to 1.0 mm. A relief printing plate 33 with an image pattern is engraved and provided on an outer circumferential face of the printing material 32.

Next, at an end of the sleeve printing plate in the direction of axis line O, there is formed a positioning notch 34 which is engaged with a guide pin erected on a cylinder of a printing apparatus to guide a relative position in the circumferential direction and in the direction of axis line O with respect to the cylinder.

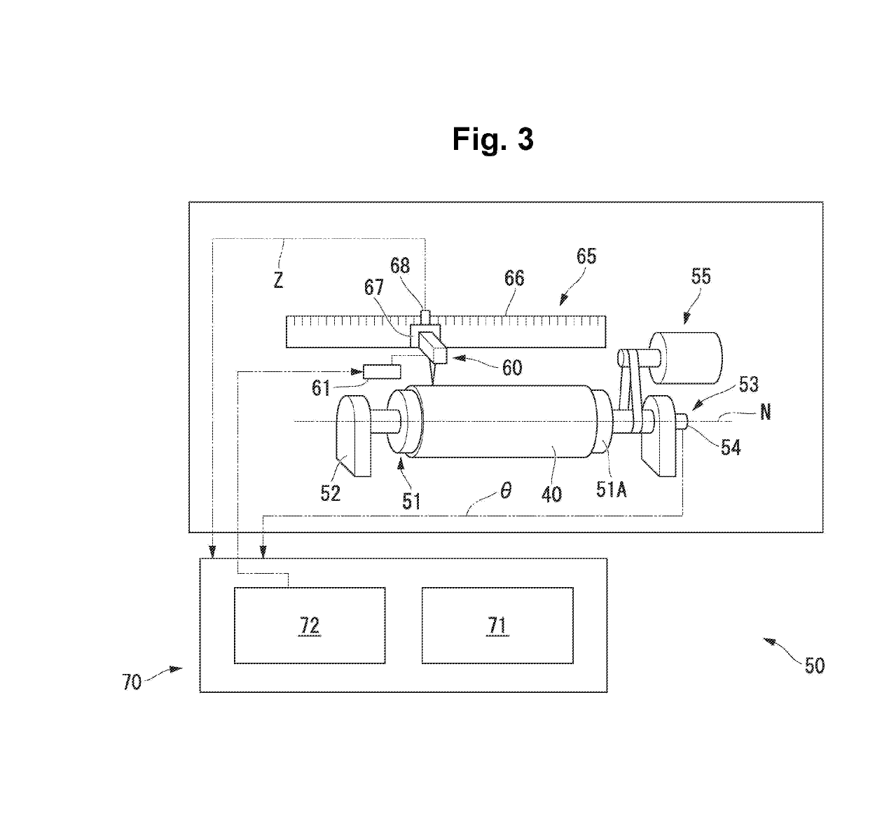

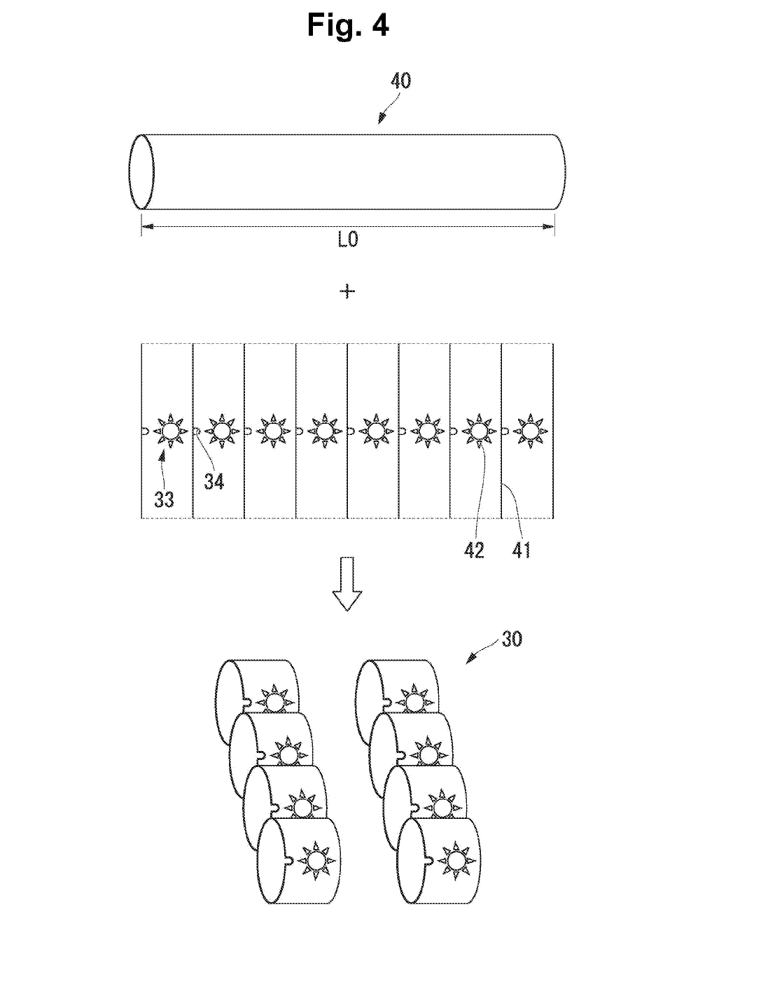

Next, an explanation will be made by referring to FIG. 3 and FIG. 4 for the apparatus 50 for producing a sleeve printing plate of the present embodiment which is used for producing the sleeve printing plate 30.

As shown in FIG. 3, the apparatus 50 for producing a sleeve printing plate of the present embodiment is provided with a sleeve element assembly-supporting unit 53 which has a rotating drum 51 and a pivot supporting portion 52, a rotation driving unit 55, a laser beam irradiating unit 60, a linear motion unit 65, and a control unit 70. The rotating drum 51 is provided with a cylindrical face 51A to which the cylindrical sleeve element assembly 40 is attached, and the pivot supporting portion 52 supports the rotating drum 51 so as to rotate freely. The rotation driving unit 55 allows the rotating drum 51 to move around the axis line N of the drum. The laser beam irradiating unit 60 irradiates a laser beam to the sleeve element assembly 40 which is attached to the rotating drum 51. The linear motion unit 65 allows the laser beam irradiating unit 60 to move in a direction parallel to the axis line N of the rotating drum 51. The control unit 70 controls the rotating drum 51, the linear motion unit 65 and the laser beam irradiating unit 60.

In this instance, the outer diameter of the rotating drum 51 is slightly greater than the inner diameter of the sleeve element assembly 40 shown in FIG. 4. On attachment to the rotating drum 51, the sleeve element assembly 40 is radially expanded due to a difference in diameter between them to generate a shrinkage force and firmly fixed to the cylindrical face 51A of the rotating drum 51. The rotating drum 51 is also provided with an air ejection mechanism (not illustrated) for ejecting air from an air hole (not illustrated) opened on the cylindrical face 51A.

Further, the sleeve element assembly-supporting unit 53 is provided with a rotating-direction position sensor 54 for obtaining rotating position information 8 of the rotating drum 51.

The linear motion unit 65 is provided with a guide bar 66, a support member 67 and an axial-direction position sensor 68. The guide bar 66 extends in a direction parallel to the axis line N of the rotating drum 51, and the support member 67 moves along the guide bar 66. The axial direction position sensor 68 obtains the position information of the support member 67 (the position information Z in the direction of the axis line N).

Next, the laser beam irradiating unit 60 is supported by the support member 67 of the linear motion unit 65 and allowed to move in a direction parallel to the axis line N. Further, the laser beam irradiating unit 60 is provided with an output adjustor 61 for adjusting the output of a laser beam. In the present embodiment, a carbon dioxide gas laser is used for the laser beam irradiating unit 60.

The control unit 70 is provided with a storage unit 71 and an energy density adjusting unit 72. The storage unit 71 stores the first image data 41 which indicates a notch forming position for positioning, a shape thereof, a cut position and a shape thereof as well as the second image data 42 indicating a position of an image pattern of the relief printing plate 33 and a shape thereof. The energy density adjusting unit 72 adjusts respectively the energy density of a laser beam in forming the notch for cutting and positioning on the basis of the first image data 41 and the energy density of a laser beam in forming the image pattern of the relief printing plate 33 on the basis of the second image data 42.

Next, on the basis of the first image data 41 and the second image data 42, the rotating drum 51, the linear motion unit 65 and the laser beam irradiating unit 60 are operated to cut the sleeve element assembly 40 and form the notch 34 and the relief printing plate 33.

Next, an explanation will be made for the method for producing a sleeve printing plate by using the apparatus 50 of the present embodiment.

First, the sleeve element assembly 40 shown in FIG. 4 is attached to the cylindrical face 51A of the rotating drum 51. At this time, one end of the sleeve element assembly 40 is fitted into the rotating drum 51 and air is ejected from the air hole by the air ejection mechanism, with this state being kept. Next, the sleeve element assembly 40 is radially expanded by the air and the sleeve element assembly 40 is attached to the rotating drum 51. At this time, the axis line O of the sleeve element assembly 40 is in alignment with the axis line N of the rotating drum 51.

In this instance, the sleeve element assembly 40 is that in which a photosensitive resin which can be engraved by a laser beam is laminated on an outer circumferential face of a polyethylene terephthalate (PET) resin, measuring 50 mm≦L0≦3000 mm in length L0 in the direction of the axis line O. In the present embodiment, L0 is equal to 1600 mm. That is, as shown in FIG. 4, eight sleeve printing plates 30 can be produced from one sleeve element assembly 40.

Next, the first image data 41 indicating a notch forming position for positioning and a shape thereof and a cut position and a shape thereof as well as the second image data 42 indicating a position and a shape of an image pattern of the relief printing plate 33 are stored at the storage unit 71.

Next, on the basis of the first image data 41 and the second image data 42, the rotating drum 51, the linear motion unit 65, and the laser beam irradiating unit 60 are controlled for actions at the control unit 70.

The rotating drum 51 is rotated by the rotation driving unit 55 while irradiating a laser beam to the sleeve element assembly 40 from the laser beam irradiating unit 60, and moved in the direction of the axis line N by the linear motion unit 65. Thereby, the laser beam irradiated from the laser beam irradiating unit 60 is used to scan an outer circumferential face of the sleeve element assembly 40 entirely. The rotation number of the rotating drum 51, that is, the rotation number of the sleeve element assembly 40 is set, for example, at 190 to 1500 rpm (a circumferential speed of 2.1 to 17.0 m/sec). The rotation number is preferably set at 200 to 1000 rpm (the circumferential speed of 2.3 to 11.0 m/sec).

In this instance, an instruction signal is sent from the energy density adjusting unit 72 to the output adjustor 61, by which the output of a laser beam is set high at a site corresponding to the first image data 41. The sleeve element assembly 40 is, thereby, removed entirely in the thickness direction. Thus, the sleeve element assembly 40 is cut and the notch 34 is formed.

On the other hand, an instruction signal is sent from the energy density adjusting unit 72 to the output adjustor 61, by which the output of a laser beam is set low at a site corresponding to the second image data 42. The sleeve element assembly 40 is, thereby, removed partially in the thickness direction. Thus, an image pattern of the relief printing plate 33 is formed on the sleeve element assembly 40.

The output of a laser beam in cutting the sleeve element assembly 40 and forming the notch 34 is set, for example, at 150 W to 1000 W, while the output of a laser beam in forming an image pattern of the relief printing plate 33 on the sleeve element assembly 40 is set, for example, at 60 W to 500 W. Further, the laser beam at a processing site is set, for example, at 0.002 mm to 0.1 mm in converging diameter. It is preferable that the laser beam is set at 60 W to 400 W in output and set at 0.008 mm to 0.08 mm in converging diameter at a processing site.

As described above, the output of a laser beam is adjusted to result in adjustment of the energy density thereof. Next, the outer circumferential face of the sleeve element assembly 40 is scanned entirely by the laser beam irradiated from the laser beam irradiating unit 60. Thereby, the sleeve element assembly 40 is scanned only once with the laser beam to cut the sleeve element assembly 40, form the notch 34 and form an image pattern of the relief printing plate 33. Eight sleeve printing plates 30 are produced from a single sleeve element assembly 40.

According to the apparatus 50 and the method for producing a sleeve printing plate by using the apparatus of the present embodiment, the positioning notch 34 is formed and an image pattern of the relief printing plate 33 is also formed in a state that the sleeve element assembly 40 is attached to the rotating drum 51 of the same sleeve element assembly supporting unit 53. Therefore, there is no chance of causing the deviation of a relative position between the notch 34 and the image pattern of the relief printing plate 33, thus making it possible to produce the sleeve printing plate 30 capable of providing a high quality printing.

Further, a laser beam is irradiated, by which the sleeve element assembly 40 is removed partially to perform cutting and also form the notch 34 and the image pattern of the relief printing plate 33. Thereby, heat resulting from processing will cause local actions, thus making it possible to suppress deformation of the sleeve printing plate 30.

The apparatus 50 is also provided with the storage unit 71 which stores the first image data 41 indicating the cutting position and the shape and the positioning notch position and the shape as well as the second image data 42 indicating the forming position of the image pattern of the relief printing plate 33 and the shape thereof. The rotating drum 51, the linear motion unit 65 and the laser beam irradiating unit 60 are controlled for actions on the basis of the first image data 41 and the second image data 42, thus making it possible to form the sleeve printing plate 30 in an accurate dimension.

Further, the energy density adjusting unit 72 adjusts the energy density of a laser beam in cutting the sleeve element assembly 40 and forming the notch 34 on the basis of the first image data 41 and also adjusts the energy density of a laser beam in forming the image pattern of the relief printing plate 33 on the basis of the second image data 42. It is, therefore, possible to freely adjust the depth of laser processing with respect to the sleeve element assembly 40. Thereby, the sleeve printing plate 30 can be formed by scanning only once the outer circumferential face of the sleeve element assembly 40 by a laser beam irradiated from the laser beam irradiating unit 60. It is, thus, possible to efficiently produce the sleeve printing plate 30 and enhance the accuracy of a relative position between the notch 34 and the image pattern of the relief printing plate 33.

Still further, in the present embodiment, the thickness of the sleeve element assembly 40 is set at 0.1 mm or more to 1.0 mm or less. Therefore, the sleeve printing plate 30 can be secured for rigidity to suppress the deformation of the image pattern and also the deformation of the notch 34 due to elongation and so on. It is also possible to efficiently perform cutting and form the notch 34 by laser processing.

In addition, in the present embodiment, a carbon dioxide gas laser is used for the laser beam irradiating unit 60. Since the laser is relatively high in output, it is possible to perform cutting and also form the notch 34 efficiently and securely.

An explanation has been so far made for the embodiments of the present invention, to which the present invention shall not be, however, restricted. The present invention may be modified in various ways within a scope not departing from the technical idea of the present invention.

An explanation has been made for a case that the laser beam irradiating unit is adjusted for output to adjust the energy density of a laser beam, to which the present invention shall not be restricted. It is acceptable that the rotating drum is decreased in rotation speed or the linear motion unit is decreased in movement speed to increase the energy density of a laser beam at a site concerned or the rotating drum is increased in rotation speed or the linear motion unit is increased in movement speed to decrease the energy density of a laser beam at the site concerned.

Further, in the present embodiment, an explanation has been made for a case that the outer circumferential face of the sleeve element assembly is scanned once by the laser beam irradiating unit, thereby performing cutting, forming the positioning notch and also forming the image pattern of the relief printing plate, to which the present invention shall not be, however, restricted. Scanning may be carried out twice or more by the laser beam irradiating unit to make the sleeve printing plate.

Further, an explanation has been made for a case that the sleeve element assembly is cut at the same time with formation of the positioning notch and the image pattern of the relief printing plate, to which the present invention shall not be, however, restricted. The cutting step may be carried out separately.

Still further, the driving unit of the rotating drum is not restricted to the illustrated constitution, and any driving unit can be used as long as it enables the rotating drum to rotate around the axis line N.

In addition, the linear motion unit of the rotating drum is not restricted to the illustrated constitution. Any linear motion unit can be used as long as it enables the laser beam irradiating unit to move in the direction of the axis line N.

The sleeve printing plate 30 to be produced is not restricted to those described in the present embodiments. It may be used such a sleeve printing plate in which a sleeve supporter is made of a fiber reinforced plastic (FRP) resin. Further, a sleeve printing plate without the sleeve supporter can be used.

### Example

Hereinafter, results are shown of experiments carried out for confirming the effect of the present invention.

A photosensitive resin-made printing material (0.6 mm in thickness) which can be engraved by a laser beam was laminated on the surface of a FRP (fiber reinforced plastic)-made substrate (0.45 mm in thickness) to prepare a sleeve element assembly to form a relief printing plate. The sleeve element assembly was 218 mm in outermost diameter and 2000 mm in length in the axial direction.

The sleeve element assembly was attached to a rotating drum 51 to cut and engrave the sleeve element assembly by a laser beam irradiated from a laser beam irradiating unit 60.

The laser beam was set at 150 W in output and at 0.01 mm in converging diameter at a site for processing the sleeve element assembly.

In this instance, where the sleeve element assembly was rotated at the rotation number of 200 rpm (a circumferential speed of 2.3 m/sec), the sleeve element assembly was removed entirely in the thickness direction by the laser beam, thus making it possible to cut the sleeve element assembly.

On the other hand, where the sleeve element assembly was rotated at the rotation number of 500 rpm (a circumferential speed of 5.7 m/sec), the sleeve element assembly was only partially removed in the thickness direction by the laser beam, thus making it possible to engrave the sleeve element assembly. The engraved depth was 0.5 mm.

Next, the laser beam was set at 0.01 mm in converging diameter at a site for processing the sleeve element assembly and the rotating drum was set at 200 rpm in rotation number.

In this instance, an output adjustor was used to adjust the output of the laser beam. In this example, there was used the output adjustor equipped with an AOM (an acoustic optical modulator).

Where the output of a laser beam was set at 150 W, the sleeve element assembly was removed entirely in the thickness direction by the laser beam, thus making it possible to cut the sleeve element assembly.

On the other hand, where the output of a laser beam was set at 60 W, the sleeve element assembly was removed only partially in the thickness direction by the laser beam, thus making it possible to engrave the sleeve element assembly. The engraved depth was 0.5 mm.

From the above example, it has been confirmed that the sleeve element assembly (the rotating drum) is adjusted for the rotation number to control the energy density of a laser beam, thereby making it possible to engrave and cut the sleeve element assembly by a laser beam by using the same apparatus.

It has also been confirmed that the output of a laser beam is adjusted at a site to be processed of the sleeve element assembly, by which the sleeve element assembly can be cut and also engraved even where the rotating drum is constant in rotation number.

An explanation has been so far made for preferred embodiments of the present invention to which the present invention shall not be, however, restricted. The present invention may be subjected to addition, omission, replacement and other modifications of the constitution within a scope not departing from the gist of the present invention. The present invention shall not be restricted to the above description but will be restricted only by the scope of the attached claims.

What is claimed is:

1. A method for producing a sleeve printing plate which is attached to a cylinder of a printing apparatus, comprising
a notch forming step wherein a laser beam is irradiated to a sleeve element assembly while rotating the sleeve element assembly attached to a rotating drum together with the rotating drum, thereby forming a positioning notch which is engaged with a guide pin erected on the cylinder; and
an image pattern forming step wherein the laser beam is irradiated to the sleeve element assembly while rotating the sleeve element assembly attached to the same rotating drum as that of the notch forming step together with the rotating drum, thereby forming an image pattern to be printed on a work piece.

2. The method for producing a sleeve printing plate according to claim 1, wherein
the notch forming step and the image pattern forming step are carried out by scanning once an outer circumferential face of the sleeve element assembly with the laser beam, while adjusting the laser beam for energy density.

3. The method for producing a sleeve printing plate according to claim 1 which is also provided with a cutting step in which while rotating the sleeve element assembly attached to the same rotating drum as that of the notch forming step and that of the image pattern forming step, the laser beam is irradiated to the sleeve element assembly to cut the sleeve element assembly into a plurality of units divided in the axial direction, and
each unit of the sleeve element assembly constitutes the sleeve printing plate.

4. The method for producing a sleeve printing plate according to claim 3, wherein
the cutting step is carried out together with the notch forming step and the image pattern forming step by scanning once the outer circumferential face of the sleeve element assembly with the laser beam, while adjusting the laser beam for energy density.

5. The method for producing a sleeve printing plate according to claim 1, wherein
the thickness of the sleeve element assembly is 0.1 mm or more to 1.0 mm or less.

6. A method for producing a sleeve printing plate which is attached to a cylinder of a printing apparatus by using a laser processing machine which is provided with a sleeve element assembly-supporting unit having a rotating drum capable of attaching a cylindrical sleeve element assembly to an outer circumferential face thereof and a pivot supporting portion for supporting the rotating drum so as to rotate, and a laser beam irradiating unit which irradiates a laser beam to the sleeve element assembly attached to the rotating drum,
the method for producing a sleeve printing plate comprising:
a notch forming step in which the laser beam is irradiated to the sleeve element assembly while rotating the sleeve element assembly attached to the rotating drum, thereby forming a positioning notch which is engaged with a guide pin erected on the cylinder; and
an image pattern forming step in which the laser beam is irradiated to the sleeve element assembly while rotating the sleeve element assembly attached to the same rotating drum as that of the notch forming step is rotated, thereby forming an image pattern to be printed on a work piece.

7. The method for producing a sleeve printing plate according to claim 6, wherein
the laser processing machine is provided with an energy density adjusting unit for adjusting the energy density of a laser beam irradiated to the sleeve element assembly, and
the notch forming step and the image pattern forming step are carried out by scanning once the outer circumferential face of the sleeve element assembly with the laser beam while adjusting the laser beam for energy density.

8. The method for producing a sleeve printing plate according to claim 6 which is also provided with a cutting step wherein while rotating the sleeve element assembly attached to the same rotating drum as that of the notch forming step and that of the image pattern forming step, the laser beam is irradiated to the sleeve element assembly to cut the sleeve element assembly into a plurality of units divided in the axial direction, and
each unit of the sleeve element assembly constitutes the sleeve printing plate.

9. The method for producing a sleeve printing plate according to claim 8, wherein
the laser processing machine is provided with an energy density adjusting unit for adjusting the energy density of a laser beam irradiated to the sleeve element assembly, and
the cutting step is carried out together with the notch forming step and the image pattern forming step by scanning once the outer circumferential face of the sleeve element assembly with the laser beam, while adjusting the laser beam for energy density.

10. The method for producing a sleeve printing plate according to claim 6, wherein
the thickness of the sleeve element assembly is 0.1 mm or more and 1.0 mm or less.

11. The method for producing a sleeve printing plate according to claim 6, wherein
a carbon dioxide gas laser is used for the laser beam irradiating unit.

12. An apparatus for producing a sleeve printing plate which is provided with a positioning notch to be engaged with a guide pin erected on a cylinder of a printing apparatus and an image pattern to be printed on a work piece and which is attached to the cylinder,
the apparatus for producing a sleeve printing plate comprising:
a sleeve element assembly-supporting unit which has a rotating drum capable of attaching a cylindrical sleeve element assembly to an outer circumferential face thereof and a pivot supporting portion for supporting the rotating drum so as to rotate;
a laser beam irradiating unit which irradiates a laser beam to the sleeve element assembly attached to the rotating drum while rotating the sleeve element assembly, thereby forming the notch and the image pattern on the sleeve element assembly; and
a control unit for controlling the rotating drum and the laser beam irradiating unit; wherein
the control unit is provided with a storage unit which stores first image data indicating a position of the sleeve element assembly on which the notch is to be formed and a shape of the notch as well as second image data indicating a position of the sleeve element assembly on which the image pattern is to be formed and a shape of the image pattern and
an energy density adjusting unit which adjusts the energy density of the laser beam in forming the notch on the basis of the first image data and in forming the image pattern on the basis of the second image data.

13. The apparatus for producing a sleeve printing plate according to claim 12, wherein
the first image data indicates a cutting position of the sleeve element assembly and a shape thereof, in addition to the position of the sleeve element assembly on which the notch is to be formed and the shape of the notch.
